(19) United States
(12) Patent Application Publication
(10) Pub. No.: US 2026/0050740 A1
(43) Pub. Date: Feb. 19, 2026

(54) Method, system and software for processing text

(71) Applicant: LIVEARENA TECHNOLOGIES INC., Bellevue, WA (US)

(72) Inventors: Strider AGOSTINELLI, Everett, WA (US); Anders NILSSON, Falköping (SE)

(21) Appl. No.: 18/882,828

(22) Filed: Sep. 12, 2024

(30) Foreign Application Priority Data
Aug. 16, 2024 (SE) 2450846-7

(51) Int. Cl. G06F 40/284

(52) U.S. Cl. CPC G06F 40/284

(57) ABSTRACT

A method for processing a piece of textual information. The piece of textual information is parsed into a set of plaintext input tokens. Each of the plaintext input tokens is individually transformed using a first binary data transformation, to achieve a set of binary input tokens. Each of the set of binary input tokens is transformed individually or collectively, using an embedding data transformation, into one or several vectorized input tokens. The one or several vectorized input tokens is/are fed to a first neural network. A response is received from the first neural network in the form of one or several vectorized output tokens.

### BACKGROUND

The various embodiments of the present invention relate to methods, systems and computer software for processing textual information. More particularly, the present invention relates to embedding-based text processing using neural networks.

There are several known ways to automatically process text information, for instance using next token prediction. Known mechanisms for processing of textual information include Recurrent Neural Networks (RNNs), and more recently, the transformers architecture.

In particular, Large language models (LLMs) have been known to be able to process unstructured data. However, LLMs have also been known to provide unreliable results.

Large language models are well-known per se and will not be described in detail herein. However, what is meant herein by a “large language model” generally is or comprises a neural network-based model that has been trained on large volumes of text information for next-token-prediction, and that is arranged to receive a prompt and to respond by a textual response. Such LLM can be based on the per se well-known transformers architecture, possibly including mechanisms for multi-head self-attention and/or positional encoding, which is well-known as such. Well-known examples of such LLMs include GPT (Generative Pre-trained Transformer) models. Such LLMs can generally be configured to accept, as input, information of various modalities, such as text, images and sound data. Non-text input can, for instance, be provided by a textual prompt containing a link or reference to the non-text information.

Other known ways of processing textual information include Convolutional Neural Networks (CNNs).

Common to such solutions are that they use so-called “embeddings”, whereby the textual input is divided into tokens, and whereby each token is assigned a unique vector in a multi-dimensional vector space. This allows the neural network or networks to compare a semantic closeness of two different tokens by comparing a distance in the multi-dimensional space between the corresponding vectors.

A general problem for processing of textual information is that it typically requires massive amounts of compute and memory resources. This applies both to training of a neural network used and for inference (the use of the trained network for producing a result).

A particular problem is that inference requires large memory resources to hold and process a long piece of textual information to be analysed.

For any solution to these problems, it is desirable to not deteriorate the results of the processing of the textual information, and that it does not take longer time for the processing to take place.

### SUMMARY

The various embodiments of the present invention solve the above-described problems.

Hence, one embodiment of the invention relates to a method for processing a piece of textual information, comprising the steps
parsing the piece of textual information into a set of plaintext input tokens; individually transforming each of the plaintext input tokens, using a first binary data transformation, to achieve a set of binary input tokens;
individually or collectively transforming each of the set of binary input tokens, using an embedding data transformation, into one or several vectorized input tokens;
feeding the one or several vectorized input tokens to a first neural network; and
receiving a response from the first neural network in the form of one or several vectorized output tokens.

In some embodiments, the method further comprises feeding the one or several vectorized output tokens to a second neural network.

In some embodiments, the method further comprises transforming the one or several vectorized output tokens, using a reverse embedding data transformation, to achieve one or several binary output tokens.

In some embodiments, the method further comprises transforming the one or several binary output tokens, using a second binary data transformation, to achieve one or several plaintext output tokens.

In some embodiments, the method further comprises feeding the one or several binary output tokens to a second neural network.

In some embodiments, the second binary data transformation is an inverse to the first binary data transformation.

In some embodiments, the first binary data transformation is a compression.

In some embodiments, the compression is a lossless compression.

In some embodiments, the compression comprises a gzip, Brotli, LZ1/LZ77, LZ2/LZ78, Huffman coding and/or BPE algorithm.

In some embodiments, the compression comprises using a set of predetermined pairs of individual plaintext token values and corresponding respective binary token values.

In some embodiments, the set of predetermined pairs is defined using one or several of a hash table, a hash map, a prefix tree and a lookup table.

In some embodiments, the set of predetermined pairs is defined, for a predetermined set of different possible plaintext tokens, as a lookup function, not involving any calculations of the corresponding binary input token.

In some embodiments, the piece of textual information is represented using only a limited character set, the limited character set comprising at the most 256 characters, such as at the most 128 characters, such as at the most 64 characters.

In some embodiments, the method further comprises converting the piece of textual information or the set of plaintext input tokens, prior to the transforming using the first binary data transformation, into a representation using only a limited character set, the limited character set comprising at the most 256 characters, such as at the most 128 characters, such as at the most 64 characters.

In some embodiments, the method further comprises the initial steps, performed before the step of parsing, of
individually transforming each of a set of plaintext training tokens, using the first binary data transformation, to achieve a set of binary training tokens;
individually or collectively transforming each of the set of binary training tokens, using the embedding data transformation, to achieve one or several vectorized pieces of training data;
individually transforming each of a set of plaintext desired output tokens, using the first binary data transformation, to achieve a set of binary desired output tokens; and
training the first neural network using the binary training tokens as input data and the binary desired output tokens as output data.

Moreover, some embodiments of the invention relate to a system for processing a piece of textual information, the system comprising
a parser, configured to parse the piece of textual information into a set of plaintext input tokens;
a first transformer, configured to individually transform each of the plaintext input tokens, using a first binary data transformation, to achieve a set of binary input tokens;
a vectorizer, configured to individually or collectively transform each of the set of binary input tokens, using an embedding data transformation, into one or several vectorized input tokens; and
a neural network interface, arranged to feed the one or several vectorized in-put tokens to a first neural network and to receive a response from the first neural network in the form of one or several vectorized output tokens.

In some embodiments, the system further comprises a reverse vectorizer, configured to transform the one or several vectorized output tokens, using a reverse embedding data transformation, to achieve one or several binary output tokens.

In some embodiments, the system further comprises a second transformer, configured to transform the one or several binary output tokens, using a second binary data transformation, to achieve one or several plaintext output tokens.

In some embodiments, the vectorizer is configured to transform each of the set of binary input tokens into one or several vectorized input tokens taking into consideration self-attention vector information of the each of the set of binary input tokens in relation to a respective local sequence of binary input tokens of the each of the set of binary input tokens in question.

In some embodiments, the vectorizer is configured to transform each of the set of binary input tokens into one or several vectorized input tokens taking into consideration positional information of the each of the set of binary input tokens in relation to a respective local sequence of binary input tokens of the each of the set of binary input tokens in question.

In some embodiments, the system is configured to associate each of the binary input tokens with metadata specifying positional information for the each of the binary input tokens.

In some embodiments, the system is configured to associate each of the binary input tokens with a respective piece of metadata specifying data storage size for the each of the binary input tokens.

In some embodiments, the system is configured to produce and store the piece of metadata using a fixed byte size data structure.

In some embodiments, the first transformer is configured to produce and store the binary input tokens with a fixed byte size.

In some embodiments, the system is configured to store the binary input tokens in a dedicated memory area of fixed-sized data entries.

In some embodiments, the piece of textual information refers to or comprises additional data that is not parsed into corresponding ones of the set of plaintext input tokens.

In some embodiments, the system is configured to store the additional data as variable-length data outside of the dedicated memory area.

In some embodiments, the system further comprises a communication interface configured to receive the piece of textual information and/or the set of plaintext input tokens from an external device, the communication interface further being configured to return the one or several plaintext output tokens to the external device.

In some embodiments, the communication interface is configured to receive the piece of textual information and/or the set of plaintext input tokens from the external device, and to return the one or several plaintext output tokens to the external device, via an HTTP socket interface configured to use a raw socket connection for data transfer.

Furthermore, some embodiments of the invention relate to a computer program product for processing a piece of textual information, the computer program product being arranged to, when executing on one or several processors,
parse the piece of textual information into a set of plaintext input tokens;
individually transform each of the plaintext input tokens, using a first binary data transformation, to achieve a set of binary input tokens;
individually or collectively transform each of the set of binary input tokens, using an embedding data transformation, into one or several vectorized input tokens;
feed the one or several vectorized input tokens to a first neural network; and
receive a response from the first neural network in the form of one or several vectorized output tokens.

The computer program product may be implemented by a non-transitory computer-readable medium encoding instructions that cause one or more hardware processors located in the system to perform the above-described method steps.

### BRIEF DESCRIPTION OF THE DRAWINGS

In the following, various embodiments of the invention will be described in detail and with reference to the enclosed drawings, wherein:

FIG. 1 illustrates a system along with various other entities, in accordance with some embodiments;

FIG. 2 illustrates a central server as well as an LLM-centric OS, in accordance with some embodiments;

FIG. 3 is a flowchart illustrating a first method, in accordance with some embodiments;

FIG. 4 illustrates a first flow of information, in accordance with some embodiments;

FIG. 5 is a flowchart illustrating a second method, in accordance with some embodiments;

FIG. 6 illustrates a second flow of information, in accordance with some embodiments; and

FIG. 7 illustrates a number of collaborating systems, in accordance with some embodiments.

### DETAILED DESCRIPTION

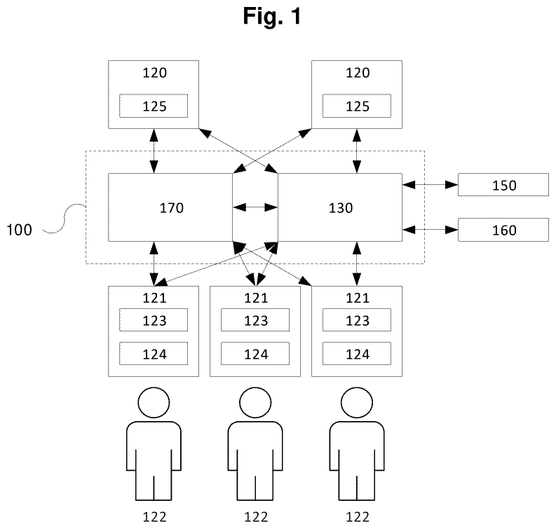

FIG. 1 illustrates a system 100, configured to perform a method of the type described herein, for processing a piece of textual information.

The textual information can be any type of information being electronically and digitally stored in a text format. The text format can be plaintext, but it can also be compressed, encrypted and similarly, as long as the system 100 is configured to transform the stored textual information into corresponding alphanumeric characters. The textual information can be sequential, in other words it has a well-defined order sequence, for instance in the form of a series of words forming a sentence or a multi-sentence text. Normally, the systems and methods described herein are arranged to process the textual information according to this defined sequence order.

The system 100 may be or comprise a central server 130.

As used herein, the term “central server” is a computer-implemented functionality that is configured to be accessed in a logically centralized manner, such as via a well-defined API (Application Programming Interface). The functionality of such a central server may be implemented purely in computer software, or in a combination of software with virtual and/or physical hardware. It may be implemented on a standalone physical or virtual server computer or be distributed across several interconnected physical and/or virtual server computers.

The physical or virtual hardware that the central server 130 runs on, in other words the physical or virtual hardware that computer software defining the functionality of the central server 130 executes on, may comprise a per se conventional CPU, possibly a per se conventional GPU, a per se conventional RAM/ROM memory, a per se conventional computer bus, and a per se conventional external communication functionality such as an internet connection.

FIG. 1 also shows a querying device 120, such as a client. The querying device 120 can also be a central server in the above sense with the corresponding interpretation, and physical or virtual hardware that the querying device 120 runs on, in other words that computer software defining the functionality of the querying device 120 executes on, may also comprise a per se conventional CPU/GPU, a per se conventional RAM/ROM memory, a per se conventional computer bus, and a per se conventional external communication functionality such as an internet connection.

The system 100 can comprise the querying device 120, or even several such querying devices 120, and/or one or several querying devices 120 can be external to the system 100. Alternatively, the querying device 120 is external to the system 100.

The system 100, such as the central server 130 or a different central server 170 of the system 100, can be configured to provide a video communication service involving two or more participating clients 121 that in turn also can be central servers in the above sense and with the corresponding interpretation. Such video communication service can be configured to allow human users 122 of the participating clients 121 to communicate with each other, digitally and automatically, using video and/or audio, via their respective participating clients 121.

Each of the one or more querying devices 120 and each of the one or more participant clients 121 can individually comprise or be in communication with a respective computer screen, configured to display video content, for instance as a part of an ongoing video communication of said type; one or several respective loudspeakers, such as configured to emit sound content provided as a part of said video communication; one or several respective video cameras; and one or several respective microphones, for instance configured to record sound locally to a user 122 to said video communication, the user 122 using the participant client 121 in question to participate in said video communication.

In other words, a respective human-machine interface of each participant client 121 can be configured to allow a respective user 122 to interact with the participant client 121 in question, in a video communication, with other users and/or audio/video streams provided by various sources.

In general, each of the querying devices 120 and each of the participating clients 121 can individually comprise a respective input means 123, that may comprise said video camera(s); said microphone(s); a keyboard; a computer mouse or trackpad; and/or an API to receive a digital video stream, a digital audio stream and/or other digital data. The input means 123 can be specifically configured to receive a video stream and/or an audio stream from a central server, such as from the central server 170, such a video stream and/or audio stream being provided as a part of a video communication and possibly being produced based on corresponding digital data input streams provided to the central server 170 from at least two sources of such digital data input streams, for instance one or several of the participant clients 121 and/or from one or several external information sources.

Further generally, each of the querying devices 120 and each of the participating clients 121 can individually comprise a respective output means 124, that may comprise said computer screen; said loudspeaker(s); and an API to emit a digital video and/or audio stream, such audio stream being representative of a captured video and/or audio locally to the participant 122 using the participant client 121 in question.

In practice, each querying device 120 and each participant client 121 can individually be a mobile device, such as a mobile phone, arranged with a screen, a loudspeaker, a microphone and an internet connection, the mobile device executing computer software locally or accessing remotely executed computer software to perform the functionality of the querying device 120 or the participant client 121 in question. Correspondingly, the querying device 120 and the participant client 121 may alternatively individually be a thick or thin laptop or stationary computer, executing a locally installed application, using a remotely accessed functionality via a web browser, and so forth, as the case may be. Each querying device 120 and each participant client 121 can also individually comprise or be connected to any peripherally connected equipment, such as any external cameras, microphones and/or loudspeakers.

There may be more than one, such as at least two, at least three or even at least four, participant clients 121 used in one and the same video communication.

Each querying device 120 can individually be one and the same logical or physical unit as one of the participant clients 121. Then, a result of the processing of the textual information described herein can be used by the participant client 121 when providing the video conference experience to the corresponding user 122 or when determining information to be sent to the central server providing the video conference experience. In other embodiments, the central server 130 can provide the results of the processing of the textual information to a querying device 120 that is external to the system 100 and not directly involved in the video communication service.

In some cases, the querying device 120 can be an internal part of the system 100, acting autonomously as a part of a larger information processing activity. For instance, an autonomous entity 125 in the form of an automatic “bot” type functionality can be configured to continuously, intermittently or discretely analyze a course of events within the video communication service. As a part of such analysis, the entity 125 can process textual information, for instance to take decisions regarding what information to provide to a requesting entity; making automatic video production decisions in the form of text-format production commands for automatic execution by the server 170 and/or based on text-format descriptions of events and/or states in and/or of the video communication service; providing a summary of the course of events; and so forth. The textual information can be automatically extracted from the video communication service, e.g. from the server 170, such as in the form of an automatically provided transcript of speech detected in the context of the video communication service; or in the form of an automatically produced textual description of a certain course of events in the context of the video communication service. The latter can, for instance, be produced based on automatic image analysis, such as using a trained neural network, of one or more video streams occurring within the video communication service, in combination with a textual processing, such as using an LLM, of metadata describing the video stream and deducted using the automatic image analysis.

An autonomous entity 125 in the form of such an automatic “bot” functionality can further be configured to provide meeting summaries for participants after a video communication service has ended. As a part of this task, the entity 125 can process textual information such as transcripts and generate a (possibly concise) summary of a discussion held between the participants during the video communication service meeting, such as by identifying and mentioning/describing key topics and action items. It can also use metadata from video streams occurring in or in connection to the video communication service to track speaker participation and to provide insights on who contributed to different discussion points. The textual information can be extracted from both speech-to-text outputs and metadata associated with the interaction dynamics, allowing for detailed post-meeting reports.

An autonomous entity 125 in the form of such an automatic “bot” functionality can further be configured to monitor the video communication service for compliance with pre-defined content standards. As a part of this task, the autonomous entity 125 can analyze textual information from speech-to-text transcripts, identifying and flagging inappropriate language or content. In addition, it can generate real-time alerts to moderators or apply automatic filters to remove or mute certain parts of the video communication service. The textual information used by the autonomous entity 125 could include speech-to-text data, contextual metadata, or keyword triggers provided by the server 170.

Moreover, an autonomous entity 125 in the form of such an automatic “bot” functionality can be configured to monitor ongoing video communications in real-time and send notifications based on certain trigger events. As a part of such monitoring, the autonomous entity 125 can analyze textual information to detect and notify users of key moments, such as speaker changes or specific keywords being mentioned. The bot could also provide real-time video control recommendations, such as switching camera feeds based on who is speaking, or generate a real-time summary of discussion points during the process of the video communication service. Textual information for these tasks can be derived from live transcripts or metadata related to the participants' interactions, extracted automatically from the video communication service by the central server 170.

It is realized that these various examples regarding the possible capabilities and tasks of the autonomous entity 125 are not meant to be exhaustive, and that the examples can be combined in any manner.

As discussed, the central server 130 and/or the entity 125 can automatically produce a video stream within the context of the video communication service. Such automatic production of the video stream is performed by taking automatic production decisions. As the term is used herein, “automatic production” of a video stream generally denotes the automatic application, by a suitably configured piece of computer software program executing on a central server of the above-described type, of a series of production decisions involving one or several input streams, such as input moving images, and resulting in one or several output streams. Such automatic production can be controlled on the basis of parameters and/or one or several trained neural networks.

FIG. 1 also shows a first neural network or LLM 150 and a second neural network or LLM 160. It is understood that an LLM comprises one or several neural networks, such as several layers and/or parallel neural network “heads”. In the following, 150 and 160 will be referred to as “LLM:s” for brevity, knowing that each of 150 and 160 can each refer to a complete LLM or merely one or several trained neural networks that in turn can form part of an LLM or of some other neural network-based functionality for processing language using such one or several trained neural networks.

The first and second LLM:s 150, 160 can each be configured to communicate with the central server 130 by the central server 130 posing queries or requests, in the form of prompts, to any of the LLM:s 150, 160, and the LLM 150, 160 then being configured to automatically respond to such prompts to the central server 130. It is realized that the LLM:s are shown in FIG. 1 to be external to the system 100, but that they individually can alternatively be internal to the system 100. In some embodiments, the central server 130 comprises one or several such LLM:s 150, 160.

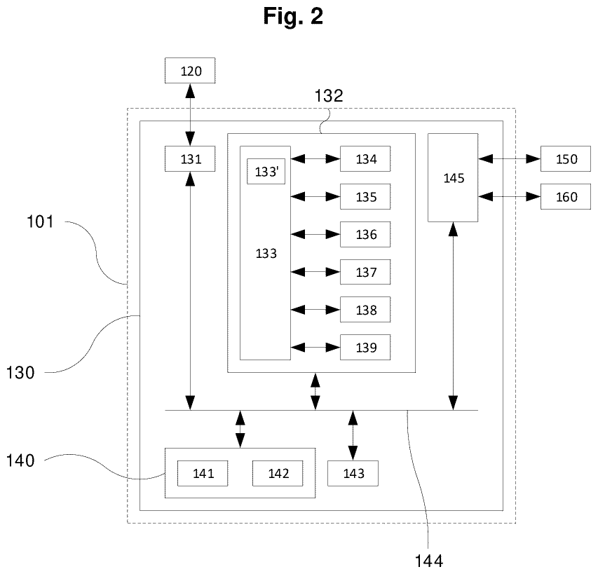

FIG. 2 illustrates in closer detail a possible embodiment of the central server 130.

The central server 130 comprises an external digital communication interface 131, such as an internet interface. The interface 131 can be a HTTP interface, and as will be exemplified below it can be configured to allow communication between the central server 130 and an external entity, such as the querying device 120, for instance using a raw socket connection.

The central server 130 further comprises a digital memory 140, such as a RAM memory. The memory 140 can comprise a part 141 arranged to store information using a fixed format, using a fixed byte size format for all information stored therein, or a respective fixed size format for two or more different types of information stored therein. The memory 140 can also comprise a part 142 arranged to store variable-sized information. It is understood that the parts 141, 142 can form part of one and the same logical memory, and that they can coexist on one and the same physical memory circuit. In some embodiments, the parts 141, 142 can be logically allocated memory areas or even one and the same memory area each being configured to be used in said way. In other embodiments, the parts 141, 142 are arranged as, or comprised in, two separate memory hardware components. In particular, the part 141 can be arranged as a hardware circuit being separated and different from a memory hardware circuit on which a computer software program is stored, the computer software program being configured to perform a method, in whole or part, of the type described herein when executed on a computing unit 143 of the central server 130.

Namely, the central server 130 further comprises the computing unit 143, such as a per se conventional CPU and/or GPU.

The central server 130 further comprises a piece of logic 132, being implemented in software and/or hardware as is per se conventional. The logic 132 can comprise a main algorithm or logic 133 implementing at least part of each of the methods described herein. The algorithm will normally be embodied as software, but can instead or additionally comprise hardware-implemented logic. The main algorithm 133 comprises or is configured to utilize various sub logics of corresponding type, such as a first binary data transformation 134, an embedding data transformation 135, a reverse embedding data transformation 136, a second binary data transformation 137, a self-attention logic 138 and/or a positional encoding logic 139. These sub logics will be described below.

The logic 132 also comprises a parser 133′, which is indicated as part of the main algorithm or logic 133 but alternatively can be a standalone module of the logic 132. The parser 133′ is configured to, when executing, parse a piece of textual information 200 into plaintext tokens 210.

The central server 130 further comprises an LLM interface 145, configured to allow the central server 130 to communicate with the LLM:s 150, 160. As discussed above, the LLM:s 150, 160 can also be comprised as a part of the central server 130. The interface 145 can utilize any suitable digital communication protocol, in particular as described above in relation to interface 131. In some embodiments, the interfaces 131, 145 are one and the same hardware and/or software interface.

The central server 130 also comprises a communication bus 144, allowing the various parts 131, 132, 140, 143, 145 to communicate one with the other.

In some embodiments, the central server 130 is a discrete physical hardware component, whereby one or several of the parts 131, 132, 140, 143, 145 (any combination of one or more of these parts) are enclosed within one and the same physical enclosure.

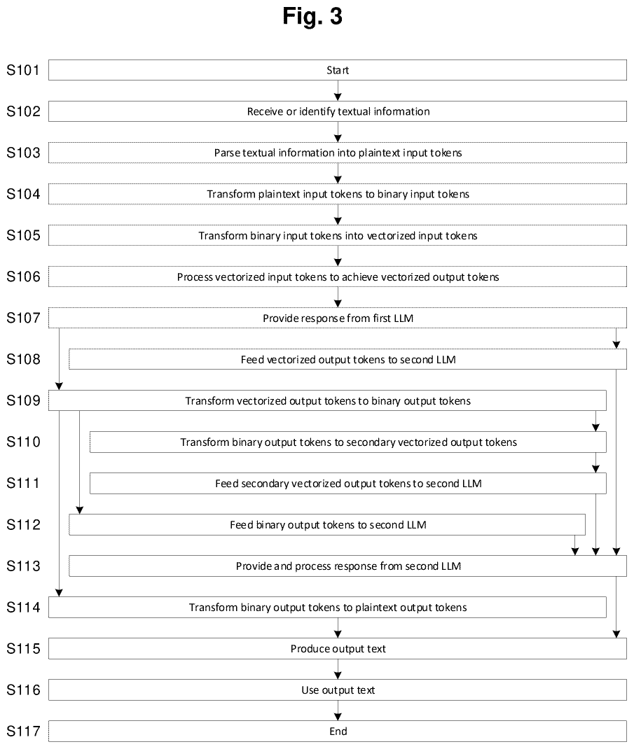

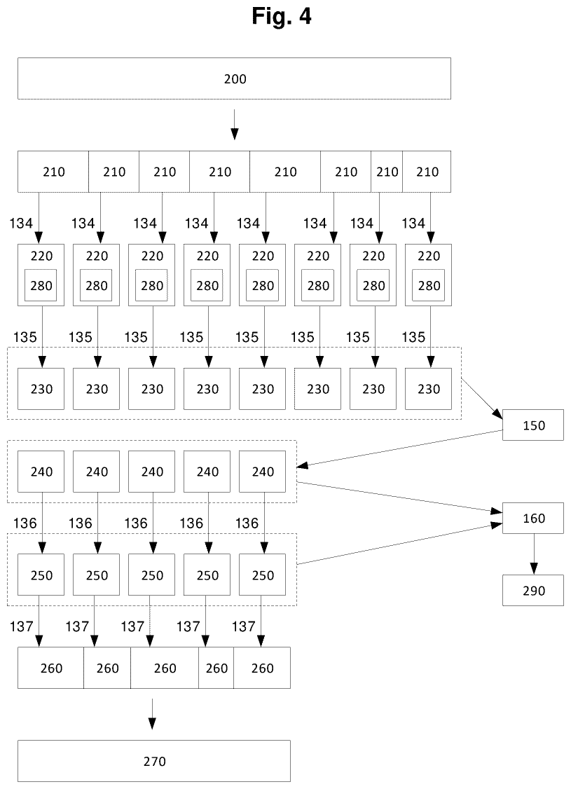

FIG. 3 is a flowchart illustrating a method for performing processing of textual information, and more particularly a piece of textual information 200 generally illustrated, by way of example, in FIG. 4. If not stated otherwise, the central server 130 can be the entity performing the steps of the method, for instance upon request from a querying device 120. Each method step can also be performed by a different entity, such as delegated by the central server 130 or under supervision by the central server 130. Unless stated otherwise, each step is performed automatically, digitally and electronically.

In a first step S101, the method starts.

In a subsequent step S102, the central server 130 receives or identifies the piece of textual information 200. As mentioned above, the central server 130 can be configured to establish the textual information 200 itself, such as by using an automatic image-to-text algorithm, an automatic video-to-text algorithm, an automatic metadata-to-text algorithm and so forth, depending on the context and what information is available to the central server 130. For example, information based on which the textual information 200 is established, such as image, video, audio, transcription and/or metadata information, can be provided from the server 170, such information possibly being part of or otherwise pertaining to an ongoing or previous video communication service. In other embodiments, the central server 130 receives the textual information from a system-external part, such as the querying device 120.

In a subsequent step S103, the central server 130 parses the piece of textual information 200 into a set of plaintext input tokens 210. Such parsing can be conventional as such, which is well-known for instance from the realm of text-based conversational and generative artificial intelligence algorithms and systems, in particular large language models. Hence, the parsing into tokens 210 can take place using various rule-based methods, such as a mapping of individual words or sequences of characters to individual plaintext tokens. The total space of available tokens 210 can be predetermined, and the parsing can then be a mapping of the piece of textual information 200 onto that space of available tokens. In simple examples, each word in the textual information 200 corresponds to one or more plaintext tokens. In these and other examples, different word endings that indicate various semantic differences can correspond to different plaintext tokens.

In a subsequent step S104, the central server 130 transforms each of the plaintext input tokens 210, using the first binary data transformation 134, to achieve a set of binary input tokens 220.

The binary data transformation 134 can be configured to produce binary input tokens 220 having arbitrarily binary data structures and sizes, depending on the detailed prerequisites and aims. However, in some embodiments the first binary data transformation 134 is a compression, such as a lossless compression. This way, the processing of the piece of textual information 200 can take place efficiently and in particular without any loss of semantic information. Useful examples of compression algorithms include gzip, Brotli, LZ1/LZ77, LZ2/LZ78, Huffman Coding and BPE (Byte Pair Encoding) algorithms. The compression can be or comprise any one or several such algorithms in combination. In general, any compression algorithm can be used, normally a lossless compression algorithm, and in particular text-specific compression algorithms are useful. Further generally, compression algorithms that are configured to convert language model tokens, or groups of language model tokens, into compressed byte sequences while maintaining semantic information have been proved useful.

Brotli is a general-purpose lossless compression algorithm well-suited for text. It can compress data to smaller sizes while maintaining relatively fast compression and decompression speeds.

LZ77 is a dictionary-based compression algorithm that replaces repeated occurrences of data with references to a single copy.

Huffman Coding is a variable-length encoding method that assigns shorter codes to more frequent tokens.

Generally desired properties of such compressions include the following:

High compression ratio: To significantly reduce the size of the token data.

Lossless compression: Ensuring no loss of essential information to maintain the semantic integrity of the text.

Fast compression and decompression speeds: To ensure that the additional steps of compression and decompression do not introduce significant latency.

Compatibility with byte data: The compression algorithm is able to handle and output data in byte format, suitable for embedding layer modifications.

In general, the first binary data transformation 134 can be configured so as to strike a balance between compression ratio, speed and a possible desire to produce fixed-size binary input tokens 220.

In a first example, the piece of information was “The quick brown fox jumps over the lazy dog.” This text was tokenized into plaintext tokens 210 according to the following: [“The”, “quick”, “brown”, “fox”, “jumps”, “over”, “the”, “lazy”, “dog”], and each of the parsed tokens was compressed using gzip into a respective binary byte sequence. It is understood that, herein, the word “binary” means that the data is represented as binary information not being readily interpretable by a human being (“plaintext”). For instance, the data 0x223D0A43 is an 8-byte binary piece of information, whereas “lazy” is a plaintext representation.

In a second example, the piece of information was “Large language models are resource-intensive.” Tokenization yielded the following plaintext tokens 210: [“Large”, “language”, “models”, “are”, “resource-intensive”], in turn being compressed using Brotli into a binary byte sequence.

Typically, the first binary data transformation is selected so that the resulting binary input tokens 220 collectively and totally comprise the same or fewer bytes of information as compared to the corresponding parts of the piece of textual information. In addition, the first binary data transformation 134 can be selected so that the resulting binary input tokens 220 individually comprise the same or fewer bytes of information as compared to the corresponding plaintext input tokens 210.

The plaintext input tokens 210 can be stored, such as in memory 140, or each plaintext input token 210 can be disregarded once the corresponding binary input token 220 has been determined. The binary input tokens 220 can be stored in memory 140, such as in the fixed-sized memory 141.

Namely, the first binary data transformation 134 can be configured to output the binary input tokens 220 as fixed-size tokens. For instance, each binary input token 220 can be stored as a fixed byte-sized datatype using at the most 4 bytes of information, such as exactly 4 bytes of information; at the most 3 bytes of information, such as exactly 3 bytes of information; such as at the most 2 bytes of information, such as exactly 2 bytes of information.

In some embodiments, respective binary input tokens 220 corresponding to each of a set of possible or available plaintext tokens 210 are stored in a hash table or hash map, whereby the hash map is configured to map each of a set of predetermined plaintext input token 210 to its compressed byte-sequence binary input token 220, providing fast lookup. Alternatively, storage of the set of corresponding binary input tokens 220 is in a prefix trie (prefix tree), providing efficient storing and retrieving of the compressed tokens. In yet other examples, a lookup table is used to map each of said set of predetermined plaintext input tokens 210 to the corresponding binary input token 220.

In general, the following can be said regarding different alternatives for the mapping between plaintext tokens and binary tokens in the presently described contexts:

Hash map: Can be selected for fast lookup of compressed byte sequences, mapping each plaintext token to its corresponding byte data.

Prefix tree (trie): For efficient storage and retrieval, especially when dealing with a large vocabulary.

Custom data structures: Optimized for specific use cases, potentially combining elements of hash maps and tries to balance lookup speed and memory efficiency.

More generally stated, the first binary data transformation 134 can be configured to use a set of predetermined pairs of individual plaintext token values 210 and corresponding respective binary token values 220, whereby the set of predetermined pairs can be defined using one or several of a predetermined deterministic rule, a hash table, a hash map, a prefix tree and a lookup table. In such and other embodiments, the set of predetermined pairs can be defined, for a predetermined set of different possible plaintext tokens 210, as a lookup function, not involving any calculations of the corresponding binary input token 220.

The set of predetermined, available and/or allowed plaintext and/or binary input tokens 210, 220 can be, in some embodiments, at the most 100000, such as at the most 50000, such as at the most 20000, or even at the most 10000.

In some examples, the parsing of the piece of textual information 200 into plaintext input tokens 210 takes place so that the parsing produces only plaintext input tokens 210 that are comprised in the predetermined set of plaintext tokens. In case parts of the textual information 200 does not map 100% to one of the predetermined plaintext tokens various mechanisms can be used to force such mapping, such as performing a most-likely mapping or having a default mapping to a generic plaintext token representing unparsable content. Alternatively, non-mappable textual information can simply be ignored.

In order to limit the amount of different possible tokens; and/or to increase the efficiency of any compression used and also subsequent vectorization (see below), the first binary transformation 134 can be configured to operate on plaintext input tokens 220 that use a limited character set. For instance, such a limited character set can be configured to comprise at the most 256 characters, at the most 128 characters or even at the most 64 characters. Either the piece of textual information 200 as received by the central server 130 can be represented using such a limited character set, or the piece of textual information 200 can be converted, if needed, into a representation using such a limited character set before being parsed. Further alternatively, each of the plaintext input tokens 210 can be converted, as needed, into such a representation using such a limited character set before the first binary transformation 134 is applied. Such a conversion can, for instance, take place using a simple many-to-one mapping of a more extensive character set onto said limited character set. As a simple example, “é”, “è” and “ê” can all be converted into “e”.

In practical examples using English-language textual information 200, the limited character set can comprise or be upwards limited to the combination of 26 letters; 10 digits; and a range of 10 defined available punctuation marks. In case Spanish is also to be supported, additional letters can be allowed, such as accented characters, and possibly also one or several additional punctuation marks. As is understood, the meaning of “limited character set” can vary depending on supported languages and the character set normally used for such languages. In general, the “limited character set” can be limited as compared to a default character set used for the one or several languages supported by the system 130.

For similar purposes as discussed above with respect to the limited character set, the system 100 can be configured to process the piece of textual information 200 to a limited set of languages, such as at the most 10 languages, or even at the most 5 languages, or even at the most 3 languages. The supported languages are preferably predetermined as being supported.

In a subsequent step S105, each of the set of binary input tokens 220 are transformed into one or several vectorized input tokens 230. Such vectorization is also known as “embedding” meaning that each of the binary input tokens 220 are mapped onto a unique multidimensional vector value in a multidimensional vector space. The “transformation” here is the embedding data transformation 135 mentioned above.

The dimensionality of said vector space can vary, but is normally at least 100, or at least 1000. The vectorization can use a predetermined or at least deterministic bijective (one-to-one) mapping of each of a set of possible binary input tokens 220 to a particular vector representation of that binary input token 220 such that each individual binary input token 220 can be unambiguously mapped to and from exactly one vector representation. This mapping can be determined ahead of time in any suitable manner, such as using a trained neural network to define the mapping in a way so that the respective vector representations (embeddings) of different tokens relate geometrically to each other in ways reflecting various semantic connections and associations among the tokens in question. For instance, geometric closeness of two different vectors in the vector space can imply semantic correlation or dependence between the corresponding different tokens. Such embedding mappings and their determination are well-known as such, and will not be detailed herein.

In general, each of the binary input tokens 220 is mapped to one or (in some embodiments possibly) several corresponding vectorized input tokens 230; and/or sets of two or more binary input tokens 220 are mapped to one or (in some embodiments possibly) several corresponding vectorized input tokens 230. In some cases, several or even many binary input tokens 220, such as a most recently processed set of such binary input tokens 220 corresponding to the textual information 200, or even all the binary input tokens 220 corresponding to the textual information 200, can be mapped onto one or (in some embodiments possibly) several corresponding vectorized input tokens 230. Further generally, the present method and system can be configured to process the binary input tokens 220 in order of appearance in the textual information 200, the order of the processing hence corresponding to a reading order of the textual information 200 to process.

If several of the binary input tokens 220 are used in combination to map to a corresponding vectorized input token 230, mechanisms such as self-attention 138 and/or positional encoding 139 can be used. As is well-known as such, the self-attention logic 138 can be configured to modify, on the margin, the vector representation 230 of a particular binary input token 220 using one or several other binary input tokens 220 occurring in a neighborhood to the particular binary input token 220, resulting in that the vector representation 230 thereof is affected (again on the margin) by the semantic context in which the particular binary input token 220 exists. The on-the-margin modification can be by way of, for instance, weighted or scaled vector addition. As is also well-known as such, the vector representation 230 of the particular binary input token 220 can be affected by the position order of the plaintext input token 210 corresponding to the particular binary input token 220 in the textual information 200 to be processed, resulting in that the ordering of the binary input tokens 220 is considered in the processing (using the positional encoding 139).

In a subsequent step S106, the one or several vectorized input tokens 230 are fed to the first LLM or neural network 150 (noting the above discussion regarding how to interpret the “LLM 150”). The first LLM or neural network 150 can be, comprise or form part of a neural network trained for next token prediction and/or the first neural network 150 can be, comprise or form part of a piece of computer software having a transformers architecture. It is noted that transformers architecture for language/text/token processing neural networks, and in particular for next token prediction, are well-known as such and will not be described in detail herein. However, it is pointed out that the first LLM or neural network 150 can comprise multiple layers of neural networks and/or intermediate calculations working together. Also, the calculations can comprise several or even many parallel flows including their own weights for self-attention, positional encoding, neural network processing and so forth, with subsequent adjoining using vector addition or similar of the individual parallel results (multiple “heads”).

The first LLM or neural network 150 hence processes the provided one or several vectorized input tokens 230 and produces a result, in the form of one or several vectorized output tokens 240. The vectorized output tokens 240 can be vectorized in, and use the same vector space as, the vectorized input tokens 230, and the vectorized output tokens 230 can be configured to be translatable into corresponding one or several binary output tokens 250 using the same mapping as discussed above.

In some embodiments, one vectorized input token 230 at a time is processed by the first LLM or neural network 150, whereby each vectorized input token 230 can contain a semantic context in the sense that it has been produced based on a corresponding binary input token 220 but also affected by the semantic context via mechanisms such as self-attention 138 and/or positional encoding 139 as described above, imparting semantic context information onto the vectorized input token 230 being processed by the first LLM or neural network 150. Then, the first neural network 150 can produce as response a single next predicted token based on the vectorized input token 230 in question, the single next predicted token being a single vectorized output token 240 corresponding, via said mapping, to a binary output token 250 in turn corresponding to a single plaintext output token 260. In such cases, all the vectorized input tokens 230 in combination correspond to the textual information 200 and all the vectorized output tokens 240 in combination correspond to a response to the textual information 200.

In some cases, additional textual information is added to the piece of textual information before or after parsing into the plaintext input tokens 210. Such additional textual information can comprise instructions to the first LLM or neural network 150 that is configured to affect the way in which the processing takes place. Sometimes this practice is referred to as “prompt engineering”.

In a subsequent step S107, as a response from the first LLM or neural network 150, the one or several vectorized output tokens 240 can be received by the central server 130.

It is realized that the one or several resulting vectorized output tokens 240 can be used in various ways. It is also realized that the one or several resulting vectorized output tokens 240 represent a semantic response corresponding to the textual information 200 if the latter is viewed as a query, a request, a statement or similar. One vectorized output token 240 can be viewed as a next token in a response thereto.

Therefore, the set of one or several resulting vectorized output tokens 240 can be fed, in a subsequent step S108, to the second neural network or LLM 160 (again noting the discussion regarding the meaning of “LLM 160” above). At this point, the set of one or several resulting vectorized output tokens 240 can be viewed as an input query, request or statement to the second neural network 160, the second neural network 160 then being configured to produce, in a step S113 and in a way that can correspond to the output by the first neural network 150 described above, a result in the form of a set of one or several secondary vectorized output tokens 290. Before the set of one or several vectorized output tokens 240 are fed to the second LLM or neural network 160, they can be amended using mechanisms such as self-attention 138 and/or positional encoding 139 in a way corresponding to what has been described above. What is important here is that the set of one or several vectorized output 240 (embeddings) can be fed directly to the second LLM or neural network 160 without having to first be mapped onto corresponding binary or plaintext tokens.

In other words, the processing of the output from the first neural network or LLM 150 to the input to the second neural network or LLM 160 can take place completely in the vector space, without any conversions to or from this vector space between the two neural networks or LLM:s 150, 160. It is realized, however, that the vectorized output tokens 240, before being fed to the second neural network or LLM 160, can be modified, such as using self-attention 138 and/or positional encoding 139 mechanisms as described above.

The set of one or several secondary vectorized output tokens 290 can be used in a way corresponding to what is described herein regarding the set of one or several vectorized output tokens 240. Hence, the set of one or several secondary vectorized output tokens 290 can be used to produce a plaintext response to a querying entity, be fed to a tertiary neural network or LLM, and so forth.

Instead of, or in addition to, feeding the vectorized output tokens 240 to the second LLM or neural network 160, the set of one or several vectorized output tokens 240 can be transformed, in a step S109, using the reverse embedding data transformation 136, to achieve one or several binary output tokens 250. The reverse embedding data transformation 136 can be inverse to the embedding data transformation 135 in the sense that the application of the embedding data transformation 135 to a (or any) binary input token 220 followed by the application of the reverse embedding data transformation 136 to the result of the embedding data transformation 135 results in the same binary input token 220.

Then, in a step S110, the set of one or several binary output tokens 250 can be vectorized, such as using the embedding data transformation 135 (or a different embedding data transformation) after any modification of the binary output tokens 250, to achieve another set of one or several secondary vectorized input tokens that are fed, in a step S111, to the second neural network or LLM 160 to be processed therein in the general manner discussed above, to achieve the secondary vectorized output tokens 290 in step S113.

In a subsequent step S114, the one or several binary output tokens 250 can be transformed, using the second binary data transformation 137 that in turn can be an inverse to the first binary data transformation 134, to achieve one or several plaintext output tokens 260.

In a subsequent step S115, an output text 270 can be produced based on the plaintext output tokens 260 and/or the secondary plaintext output tokens, for instance by concatenating said plaintext tokens.

In a subsequent step S116, the output text 270 is used. For instance, the resulting output text 270 can be stored in memory 140; returned to the system-external part that provided the piece of textual information 200 to the system; or be used in any suitable manner, such as being parsed, processed or inspected to find information in turn used in some process, for instance within the video communication service provided by the central server 170. In other embodiments, the output text 270 can be used to produce results in a search engine;

constitute a response from a chatbot; or constitute a translation from an automatic translation service.

In general, the output text 270 can be made available to system 100 external entities via interface 131. Concretely, the communication interface 131 can be configured to receive the piece of textual information 200 and/or the set of plaintext input tokens 210 from the external device (such as querying device 120), and to return the output text 270 or the one or several plaintext output tokens 260 (realizing that the output text 270 generally comprises or is determined based on the plaintext output tokens 260) to the external device. Then, such receiving and/or returning can take place via an HTTP socket interface, the HTTP socket interface possibly being configured to use a raw socket connection for data transfer. This provides for very efficient data IO, in particular in case the communicated data is on token level and following a predetermined efficient data format.

In practical examples, the communication interface 131 can be configured to communicate data using a predetermined binary format that represents each token as a fixed-length binary string. For instance, according to such a predetermined binary format each token is represented by an 8-bit binary string. A word token might be represented as binary string 00000001, a punctuation token as 00000010, and so on. This binary representation is efficient because it allows for compact data transmission and quick parsing by the receiving neural network or LLM.

The following is a concrete example of communication across the communication interface 131:
1. The querying device 120 sends a query to the central server 130 via the HTTP socket interface.
2. The central server 130 receives the query and converts it into binary input tokens 220 using the first binary data transformation 134.
3. These binary input tokens 220 are then processed as described herein and transformed into vectorized output tokens 240.
4. If necessary, the vectorized output tokens 240 can be de-vectorized, using the reverse embedding data transformation 136, into binary output tokens, that in turn can be modified, such as using self-attention and/or positional encoding, and then be re-vectorized into vectorized input tokens 230 after such modifications, and again processed into vectorized output tokens 240.
5. The vectorized output tokens 240 can be further processed or used to generate the plaintext output tokens 260.
6. The final output, in the form of the plaintext tokens 260, is then sent back from the central server 130 to the querying device 120 using the HTTP socket interface.

The efficiency of this process lies in the use of a raw socket connection for data transfer, which minimizes overhead and maximizes throughput. This is possible since both communicating parties 120, 130 use a predetermined simple format for communication of the information (namely, only tokens of predetermined format).

As an alternative to feeding the vectorized output tokens 240 or the secondary vectorized output tokens 290 to the second neural network or LLM 160, the one or several binary output tokens 250 can be fed, in a step S112, directly to the second neural network or LLM 160. Then, the second neural network or LLM 160 can be configured to transform the binary output tokens 250 into a corresponding set of one or several secondary vectorized output tokens 290 for subsequent processing into a corresponding response from the second neural network or LLM 160. Alternatively, the second neural network or LLM 160 can be configured to process the binary output tokens 250 directly to achieve a response.

In a practical example, the piece of textual information 200 was “What is the capital of France?” This piece of textual information 200 was amended to read “What is the capital of France? Be concise.” This text was parsed to form plaintext input tokens 210 {“What”, “is”, “the”, “capital”, “of”, “France”, “?”, “Be”, “Concise”, “.”}. The plaintext tokens 210 were converted into a corresponding set of compressed binary byte sequence values 220, in turn being vectorized into vectorized input tokens 230 fed to the first LLM 150. The output was vectorized output tokens 240, converted into corresponding compressed binary output tokens 250 that were decompressed to form plaintext output tokens 260 {“The”, “capital”, “of”, “France”, “is”, “Paris”, “.”}. These plaintext output tokens 260 were concatenated to form the plaintext output text 270 “The capital of France is Paris.”

In some alternative embodiments, the conversion between binary tokens and vectorized tokens, either or both ways, can be performed by the LLM or neural network 150, 160. In such cases, an embedding and/or input layer of the LLM or neural network 150, 160 can be modified to be able to accept and process binary tokens (that can be fixed-size tokens) instead of plaintext tokens. This can involve, for example, the embedding matrix of the model beings adjusted to map byte sequences of the present type to vectors.

As mentioned, the neural networks 150, 160 do not have to be LLM:s. Namely, other types of neural network setups, such as RNN:s and CNN:s, can be adjusted both in terms of input layers and training routines (see below) in ways corresponding to the ones described herein, for instance by modifying their respective input layers, to be used in connection to the presently described solutions. For instance, the cell inputs of an RNN can be modified to accept compressed binary byte sequence input tokens.

The first and/or second LLM or neural network 150, 160 can be or comprise a neural network that is trained using training data comprising binary coded training tokens of the same type as the binary input tokens 220. Such training can, for instance, comprise allowing the first and/or second LLM or neural network 150, 160 to process an input binary training token that can be modified using self-attention and/or positional encoding as described above, and using a next input binary training token a same series of ordered input binary training tokens as the desired output, and then adjusting a set of weights of the first and/or second LLM or neural network 150, 160 as a function of a noted discrepancy between the desired output and the produced result of the first and/or second LLM or neural network 150, 160.

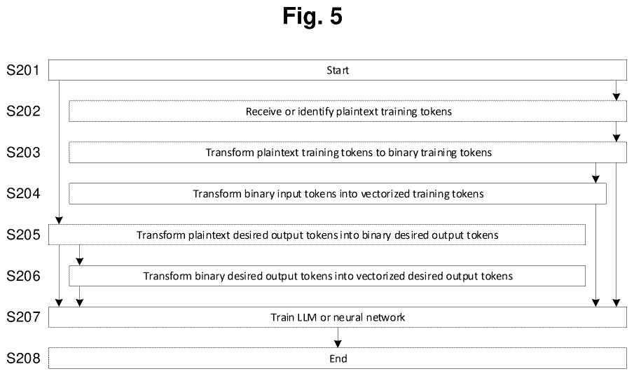

FIG. 5 illustrates a method for performing such training. The steps illustrated in FIG. 5 can be part of the presently described method and can be performed at any time before the steps illustrated in FIG. 3. Of course, retraining and/or post-training can occur at any time, for instance by again performing some or several of the method steps illustrated in FIG. 5.

Hence, in a first step S201, the method starts.

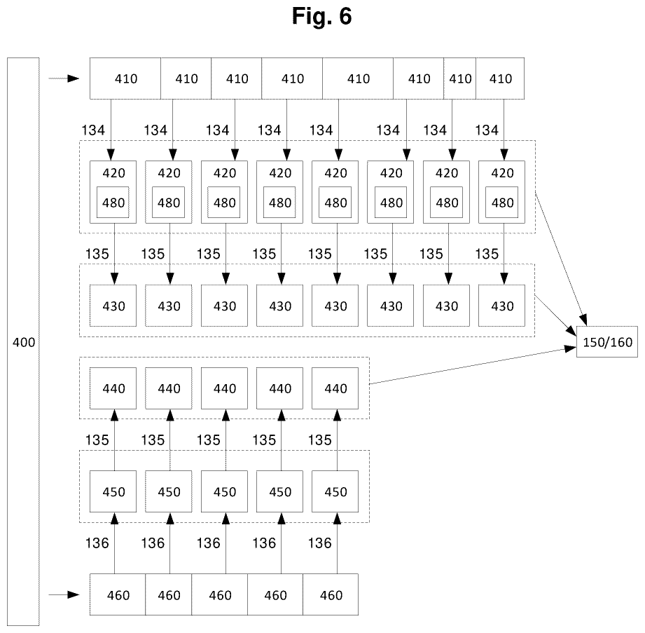

In a subsequent step S202, forming part of a series of initial steps (S202-S207) that can be performed before the step of parsing S103 or at least before the inference step S106, a set of plaintext training tokens 410 (see FIG. 6) are received or identified. This receiving or identifying can take place in a corresponding manner as described above in connection to step S102. In particular, the set of plaintext training tokens 410 can be parsed from a piece of plaintext textual training information 400 used for training in a way that can correspond to what has generally been described in connection to step S103. It is understood that the steps illustrated in FIG. 5 are generally steps for training of the neural networks of 150 and/or 160, whereas the steps illustrated in Figure are generally steps for inference using 150 and/or 160. Herein, the word “training” generally refers to the determination of weights and/or other parameters of a neural network, whereas “inference” means using the trained neural network to calculate, based on the weights etc., a result based on an input.

In alternative embodiments, the set of plaintext training tokens 410 are simply provided as they are instead of being parsed.

In a subsequent step S203, performed before step S207, each of the set of plaintext training tokens 410 are individually transformed into a set of binary training tokens 420. This transformation can be as generally described in connection to step S104, and uses the first binary data transformation 134, and can include mechanism such as self-attention and/or positional encoding. In alternative embodiments, the binary training tokens 420 are provided as they are instead of being neither parsed nor binary-transformed.

In a subsequent step S204, also performed before step S207, each of the set of binary training tokens 420 can be individually or collectively transformed into one or several vectorized training tokens 430. This transformation can be as generally described in connection to step S105 and uses the embedding data transformation 135. In alternative embodiments, the vectorized training tokens 430 are provided as they are instead of being neither parsed nor binary-transformed or vector-transformed.

In a step S205, that is performed before step S207, each of a set of one or several plaintext desired output tokens 460 are transformed, also using the first binary data transformation 134, to achieve a set of one or several binary desired output tokens 450. This transformation can also take place as is generally described in connection to step S104. The one or several plaintext desired output tokens 460 can be received or identified in a way that can generally correspond to how the plaintext training tokens 410 are received or identified in step S202. In particular, each or the plaintext desired output token 460 can be a next plaintext token in an ordered series of plaintext tokens corresponding to the plaintext piece of textual training information 400. In alternative embodiments, the set of one or several binary desired output tokens can be provided or identified as it is, without performing the first binary data transformation 134, for instance by the training being applied on a pre-existing sequence of binary tokens.

In a subsequent step S206, that is also performed before step S207, each of the set of one or several binary desired output tokens 450 can be individually or collectively transformed into one or several vectorized desired output tokens 440. This transformation can be as generally described in connection to step S105 and then uses the embedding data transformation 135. Again, in alternative embodiments the one or several vectorized desired output tokens may be identified as they are, instead of performing neither the first binary transformation 134 nor the vectorization transformation 135.

Then, in a subsequent step S207, the first and/or second LLM or neural network 150, 160 is or are trained using the binary training tokens 420 as input data and the binary desired output tokens 450 as output data. The training can be performed in a per se conventional manner, using weight adjusting as a function of a discrepancy between, firstly, an output of the first and/or second LLM or neural network 150, 160 and, secondly, the corresponding binary desired output token 450. The adjusting function can be or comprise, as an example, gradient descent.

That the first and/or second LLM or neural network 150, 160 is or are trained using the binary training tokens 420 as input data means that the binary training tokens 420 are used for the training directly or via additional calculations, and correspondingly for the binary desired output tokens 450 and the vectorized desired output tokens 460. For instance, the training can take place based on the vectorized training tokens 430 and the vectorized desired output tokens 440, that are first calculated from the binary training tokens 420 and the binary desired output tokens 450 using the embedding data transformation 135.

In a subsequent step S207, the method ends.

Using such method, the first and/or second LLM or neural network 150, 160 is or are trained in a way so as to provide relevant responses to subsequent inputs formatted as the plaintext input tokens 210, binary input tokens 220 or vectorized input tokens 220, such input possibly first being modified using suitable transformations 134, 135.

As mentioned above, some embodiments of the invention also relates to the system 100 for performing the methods described herein, and more particularly for processing the piece of textual information 200.

The system 100 comprises the parser 133′, the first transformer 134, the vectorizer 135 and the neural network interface 145, and it can also comprise the reverse vectorizer (embedding transformation) 136 and/or the second binary data transformation 137.

As also mentioned, the vectorizer 135 can be configured to transform each of the set of binary input tokens 220 into the one or several vectorized input tokens 230 taking into consideration self-attention vector information of the binary input tokens 220 in relation to a respective local sequence of binary input tokens 220 of the binary input token 220 in question. Furthermore, the vectorizer 135 can be configured to transform each of the set of binary input tokens 220 into one or several vectorized input tokens 230 taking into consideration positional information of each binary input token 220 in relation to a respective local sequence of binary input tokens 220 of the binary input token 220 in question.

FIGS. 4 and 6 show that each of the binary input tokens 220 can comprise metadata 280, and that each of the binary training tokens 420 can comprise metadata 480. Namely, the system 100 (such as the main algorithm 133 or the first transformer 134, can be configured to associate one, several or each of the binary input tokens 220 with the metadata 280. In practical examples, the metadata 280 can form part of the binary input token 220, be stored separately from but associated with the binary input token 220, or similar.

The metadata 280 can be configured to specify various information relating to the binary input token 220 to which it relates, such as positional information for the each of the binary input token 220; a data storage size for the binary input token 220; token length for the binary input token 220; binary input token 220 overall frequency; and so forth. In examples, a sequence of binary input tokens 220 representing a sentence, positional metadata indicates the order of each of the binary input tokens 220, allowing for maintaining context in tasks like translation or summarization and understanding the relative importance of each token, preventing it from confusing word order or relationships. By having metadata specify attributes like frequency or usage context, the model can give more weight to important tokens and process less significant ones faster.

The corresponding can apply to the metadata 480 as a part of or in relation to the binary training token(s) 420.

As mentioned above, the memory part 141 can be arranged to store information using a fixed byte size storage format. In some embodiments, each piece of metadata 280, 480 can be stored using such fixed byte size storage format in the memory part 141. In these and in other cases, the first transformer 134 can be configured to produce and store the binary input tokens 220 and/or the binary training tokens 420 using such a fixed byte size format in the memory part 141.

Hence, the memory part 141 can be used to store, using one or several fixed byte size storage formats, such as one or several different binary storage formats, one, or any combination of two, three, four, five, six, seven, eight, nine or ten of the following types of information: The metadata 280, the metadata 480, binary input tokens 220, the vectorized input tokens 230, the vectorized output tokens 240, the binary output tokens 250, the binary training tokens 420, the vectorized training tokens 430, the vectorized desired output tokens 440 and the binary desired output tokens 450.

Moreover, the piece of textual information 200, the plaintext input tokens 210, the binary input tokens 220, the binary output tokens 250 and/or the plaintext output tokens 260 can comprise one or several references to non-parsed and/or non-tokenized information, such as metadata, image data, video data, audio data, structured data, and so forth. Such information can then be stored in the variable memory length memory part 142, being referenced from the token 210, 220, 250 and/or 260 in question and accessed therefrom by the main algorithm 133 as needed.

As an example, when an image is processed (such as via reference in the piece of textual information 200), metadata associated with the image (including the start address and size) is stored in a fixed-length slot in memory 141. The image data itself is stored in a variable-length slot in memory 142, allowing for efficient use of memory. This setup enables quick access to metadata for any data retrieval or processing tasks, while efficiently managing the variable-sized data blocks.

Using the principles described herein, a computer operating system (OS) can be constructed as an OS centered around one or several LLMs and optimized for fast and resource-efficient information processing using these LLMs. Unlike conventional OS: s that rely on higher-level programming languages for development, such an LLM-centric OS can operate directly with binary data and machine code. In some aspects, embodiments of the present invention relate to such an LLM-centric OS, comprising or being the system 100 or the central server 130.

More concretely, the LLM-centric OS can accept prompt information to be fed directly to the LLM 150, 160 with or without preprocessing of the prompt information. Then, the output from the LLM 150, 160 can be directly returned to the querying device 120 or delivered via a suitable external interface 131 for any desired subsequent use. The “prompt information” can be the piece of textual information 200, the already parsed plaintext input tokens 210 or any information using which the LLM-centric OS readily can construct the piece of textual information 200, the plaintext input tokens 210, the binary input tokens 220 and/or the vectorized input tokens 230. Such construction can then form part of any preprocessing performed by the LLM-centric OS. In some embodiments, the “prompt information” can be the binary input tokens 220 or even the vectorized input tokens 230, such as when two LLM-centric OS: s communicate one with the other. This provides for very efficient usage of several such LLM-centric OS: s in a network, collaborating on solving various tasks. The vectorized output tokens 240, the binary output tokens 250, the plaintext output tokens 260 and/or the output text 270 can, after any suitable post-processing, be delivered directly over the interface 131.

This approach provides several advantages as compared to a conventional general-purpose computer running a conventional general-purpose OS in turn running an LLM. Such advantages include increased efficiency and performance, as it eliminates the overhead associated with interpreting higher-level code.

It is understood that the system 100 and/or the central server 130 can in itself form, together with additional software functionality such as suitable hardware drivers and similar, a full-fledged OS in which the calls to the LLM:s 150, 160 are performed within a core of the OS. In such cases, the OS can be a text-only OS, in some cases so that the interfaces 131, 145 is (in case they are one and the same) or are the only external interface(s) exposed by the OS for communication with external entities. In other examples, the system 100 can form an integrated part of the OS, and the OS can additionally comprise conventional functionality such as an interactive graphical user interface (GUI). In all such examples, the functionality of the system 100 and/or the central server 130 described herein can be configured to execute as a part of a kernel process of the LLM-centric OS.

The LLM-centric OS can be configured to run on a dedicated piece of hardware 101 (see FIG. 2) that is arranged to run logic implemented in software and/or hardware that constitutes the central server 130. In that case, the one or several interfaces 131, 145 can be one or several physical external interfaces of the piece of hardware 101, and possibly the only external digital communication interfaces of the piece of hardware 101. In other words, the piece of hardware 101 can be configured so that it can receive prompt information and deliver responses to such prompt information, for instance only in digitally stored plaintext or reformatted (such as compressed, encoded, vectorized or similar) text format.

The LLM 150, 160 itself or themselves can form part of the OS directly and/or be external in relation to the OS. The former provides improved speed; the latter provides improved modularity and simpler upgrading.

Such an LLM-centric OS should of course be designed to be compatible with the specific CPU architecture it will run on, such as x86 or ARM. This involves understanding and utilizing the specific machine instructions of the CPU for implementing the various method steps described above, to ensure smooth and efficient execution of these tasks.

Such an LLM-centric OS can be used to integrate transformer models, transformer models being neural network architectures designed for handling sequential data. As discussed above, these models can use mechanisms such as self-attention and positional encoding to process and take into consideration the context of input data. For the LLM-centric OS: s described herein, the corresponding transformer model can be adapted in the ways described to handle binary data as opposed to plaintext or non-compressed token data, creating embeddings from this data and ensuring compatibility with the transformer's input requirements; and/or they can be adapted to handle vectorized data directly.

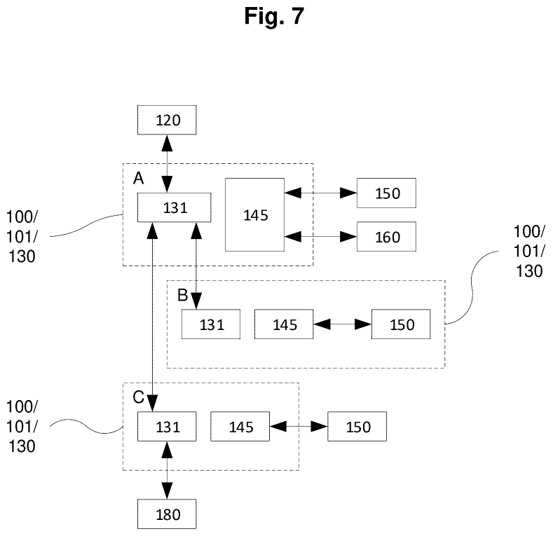

FIG. 7 illustrates some examples of configurations utilizing one or several LLM-centric OS: s, including:
A first LLM-centric OS A, that can be implemented as software and/or hardware, and in particular as a virtual or physical discrete device as described above, communicating with a querying device 120 of the above-described type, and configured to provide responses to the querying device 120 to queries or requests, the queries or requests being or being transformable into LLM prompts.
The first LLM-centric OS A being configured to communicate with external LLM:s 150, 160.
A second LLM-centric OS B, that can be of any one of the same or corresponding type as the first LLM-centric OS A, being configured to communicate with the first LLM-centric OS A, for instance by receiving requests, LLM prompts and/or plaintext/binary/vectorized tokens from the first LLM-centric OS A; to process such information using an internal LLM 150 and to provide a corresponding response to the first LLM-centric LLM A.
A third LLM-centric OS C, that also can be of any one of the same or corresponding type as the first LLM-centric OS A, being configured to communicate with the first LLM-centric OS A, for instance by receiving requests, LLM prompts and/or plaintext/binary/vectorized tokens from the first LLM-centric OS A; to process such information using an external LLM 150 and to provide a corresponding response to the first LLM-centric LLM A.

It is understood that the specific configuration shown in FIG. 7 involves a number of possible configuration examples, not intended to be full-fledged but rather selected so as to illustrate the different possible ways in which a set of two or more, such as three or more, LLM-centric OS: s of the presently described type can be configured to work collaboratively together to solve various tasks. For instance, such collaboration can take place in a tree-like or graph-like communication structure between the LLM-centric OS: s. Each LLM-centric OS can delegate any sub-task, such as specific functionality or as a part of a parallelization effort, to other LLM-centric OS: s.

Data in the LLM-centric OS can be stored and accessed, using the above-described principles relating to the memory 140, in a manner that optimizes speed and efficiency. Hence, the LLM-centric OS can use a structured approach to memory management that separates static-length entries from variable-length entries as will be described in the following.

Each data entry can comprise or be associated with, such as be preceded by, metadata 280, 480 that includes positional data and the size of the data entry. This metadata 280, 480 can then be configured to allow the main algorithm 133 to quickly access and manage memory, facilitating faster data retrieval and processing. The positional data helps in locating the data, while the size information ensures that the system knows how much data to read or write.

The static-length data entries in the memory part 141 have a fixed byte size and can therefore be accessed very quickly. They can be stored in the dedicated area 141 of the memory 140 where each data entry occupies the same amount of space.

The variable-length entries in the memory part 142 vary in size and can be stored separately from the static-length entries, such as in a separate memory circuit or in a different allocated memory circuit. When variable data needs to be accessed, the system can use the metadata 280, 480 to locate and read the appropriate amount of data.

From a general point of view, the various components 131-145 can be configured to ensure seamless operation of the LLM-centric OS to perform LLM-centric tasks. For example, memory management routines, interrupt handling, and input/output processing via network devices can be finely tuned to operate efficiently within the constraints of the selected CPU architecture and the requirements of the selected transformer model(s) 150, 160. This structured approach can be used to ensure that the LLM-centric OS can process binary data directly, providing a highly efficient and powerful platform for computational tasks.

In traditional computing, OS: s and applications are built using high-level programming languages like Python or C. These languages, even when compiled into machine code, provide abstractions that simplify development but add layers of overhead. When these applications need to handle tasks such as text processing or networking, they rely on extensive libraries and APIs, which, while convenient for the software developer, can be inefficient. For instance, a standard text processing application would read text data, process it through various layers of software, and produce output. Each layer, from file I/O to string manipulation libraries, introduces latency and resource consumption. Generally, problems that may result from such architectures include performance overhead, making real-time processing challenging; higher resource consumption in terms of memory and CPU usage; latency; and complexity, making development, debugging and maintenance burdening.

In contrast thereto, the principles described herein allow the configuration of an LLM-centric OS that can directly process binary data and machine code, and in particular utilize transformer (LLM) models to handle complex tasks such as text processing, without the need for high-level languages or extensive software libraries. Hence, instead of designing complex algorithms in high-level languages for compilation and execution, embodiments of the present invention proposes to push at least some of the functionality to an LLM accessed in the ways described herein. Such LLM-centric OS: s can be configured to operate internally, using network devices for inputs and outputs via HTTP requests as described herein.

Using these principles, performance overhead can be decreased since data is processed directly in binary form and using machine code, eliminating the overhead associated with higher-level abstractions and resulting in faster processing times. Resource consumption can be decreased since the operation directly with machine code and binary data significantly reduces memory and CPU usage due to the fewer layers of processing. Latency can be decreased due to said direct processing and efficient memory management. Finally, complexity is decreased, since the system 100 (or central server 130) can be configured to offer a direct route for handling binary data and directly using transformer models for complex processing tasks, effectively reducing the complexity involved in managing multiple libraries and dependencies.

Below is a high-level pseudocode representation of part of the kernel of an LLM-centric OS of the type generally described herein designed to handle binary data and machine code directly, integrating a transformer model (LLM), and using external network devices (such as querying device 120) for input and output via HTTP requests.

```
BEGIN LLM_OS
  // Memory Management Setup
  INIT memory_table
  INIT static_memory_area
  INIT variable_memory_area
  // Interrupt Handling Setup
  SETUP IDT
  DEFINE ISRs
  // Network Setup
  INIT network_socket
  BIND network_socket TO PORT 80
  LISTEN network_socket
  // Main Loop
  WHILE true DO
    // Accept incoming network connection
    connection = ACCEPT(network_socket)
    // Parse HTTP request
    request = PARSE_HTTP_REQUEST(connection)
    payload = request.payload
    // Binary Data Handling
    metadata = EXTRACT_METADATA(payload)
    binary_data = CONVERT_TO_BINARY(payload)
    // Embedding Transformation
    embeddings = TRANSFORM_TO_EMBEDDINGS(binary_data)
    // Feed into Transformer Model
    transformer_output = TRANSFORMER_MODEL_PROCESS(embeddings)
    // Reverse Transformation
    output_embeddings = TRANSFORM_TO_BINARY(transformer_output)
    output_payload = ADD_METADATA(output_embeddings, metadata)
    // Generate HTTP Response
    response = CREATE_HTTP_RESPONSE(output_payload)
    SEND_RESPONSE(connection, response)
    // Close connection
    CLOSE(connection)
  END WHILE
  // Memory Management Functions
  FUNCTION EXTRACT_METADATA(data):
    metadata = PARSE(data, HEADER)
    RETURN metadata
  END FUNCTION
  FUNCTION CONVERT_TO_BINARY(data):
    binary_data = BINARY_ENCODING(data)
    RETURN binary_data
  END FUNCTION
  FUNCTION TRANSFORM_TO_EMBEDDINGS(binary_data):
    embeddings = EMBEDDING_TRANSFORMATION(binary_data)
    RETURN embeddings
  END FUNCTION
  FUNCTION TRANSFORM_TO_BINARY(embeddings):
    binary_data = BINARY_DECODING(embeddings)
    RETURN binary_data
  END FUNCTION
  FUNCTION ADD_METADATA(data, metadata):
    output_payload = CONCAT(metadata, data)
    RETURN output_payload
  END FUNCTION
  // Transformer Model Process Function
  FUNCTION TRANSFORMER_MODEL_PROCESS(embeddings):
    attention_output = ATTENTION_MECHANISM(embeddings)
    feed_forward_output = FEED_FORWARD(attention_output)
    RETURN feed_forward_output
  END FUNCTION
  // Network Functions
  FUNCTION PARSE_HTTP_REQUEST(connection):
    request = READ(connection)
    parsed_request = PARSE(request)
    RETURN parsed_request
  END FUNCTION
  FUNCTION CREATE_HTTP_RESPONSE(data):
    response = FORMAT_HTTP_RESPONSE(data)
    RETURN response
  END FUNCTION
  FUNCTION SEND_RESPONSE(connection, response):
    WRITE(connection, response)
  END FUNCTION
END LLM_OS
```

The following are explanations to some of the concepts used and mentioned in the above pseudocode:
Memory Management Setup: Initializes memory areas for static and variable data, and a memory table to track allocations.
Interrupt Handling Setup: Sets up the Interrupt Descriptor Table (IDT) and defines Interrupt Service Routines (ISRs).
Network Setup: Initializes a network socket, binds it to port 80, and begins listening for incoming connections.
Main Loop: Continuously accepts incoming HTTP connections, processes the requests, and generates appropriate responses.
   Accept Connection: Accepts a new network connection.
   Parse HTTP Request: Parses the incoming HTTP request to extract the payload.
   Binary Data Handling: Extracts metadata and converts the payload to binary data.
   Embedding Transformation: Transforms the binary data into embeddings suitable for the transformer model.
   Transformer Model Process: Feeds the embeddings into the transformer model for processing.
   Reverse Transformation: Converts the transformer's output embeddings back to binary data and adds metadata.
   Generate HTTP Response: Creates an HTTP response with the processed data and sends it back to the client.
   Close Connection: Closes the network connection.
   Functions: Defines utility functions for memory management, binary data handling, and network communication.

As mentioned above, each machine-language instruction in such an implementation should be carefully crafted to perform basic operations like data movement, arithmetic, logic, and control flow, in dependence on the particular features that are available for the particular CPU architecture that is selected for the implementation.

The binary data handling performed by the LLM-centric OS typically involves transforming binary sequences into embeddings, which it is reminded are multi-dimensional vector representations that the neural network 150, 160 can process.

Metadata can be stored in fixed-length memory slots in memory area 141, ensuring fast access and reducing fragmentation, for instance using the following header Layout: [4 bytes: Start Address] [4 bytes: Data Length] [4 bytes: Checksum] [4 bytes: Flags].

An example of a binary data to embedding transformation is the following:

```
FUNCTION binary_to_embedding(binary_data):
  embeddings = [ ]
  FOR each byte IN binary_data:
    vector = CONVERT_BYTE_TO_VECTOR(byte) // Maps byte to 128-d vector
    embeddings.APPEND(vector)
  RETURN embeddings
END FUNCTION
```

As discussed, transformers can use self-attention mechanisms and positional encodings to process input sequences. Adapting this for binary data involves ensuring that the embeddings created from binary sequences are compatible with these mechanisms. An exemplary self-attention mechanism can look as follows, computing the relevance of each individual token in a sequence to every other token in the sequence:

```
FUNCTION attention_mechanism(embeddings):
  attention_scores = [ ]
  FOR each embedding_i IN embeddings:
    score = [ ]
    FOR each embedding_j IN embeddings:
      score.APPEND(CALCULATE_SCORE(embedding_i, embedding_j))
    attention_scores.APPEND(NORMALIZE(score))
  RETURN attention_scores
END FUNCTION
```

The following is a corresponding example of an algorithm for positional encoding, adding information about the position of tokens in the sequence:

```
FUNCTION positional_encoding(embeddings, max_length):
  position_encoded = [ ]
  FOR i IN range(0, len(embeddings)):
    encoded_vector = [ ]
    FOR j IN range(0, len(embeddings[0])):
      angle = i / (10000\hat{ }(2 * (j//2) / len(embeddings[0])))
      IF j % 2 == 0:
        encoded_vector.APPEND(sin(angle))
      ELSE:
        encoded_vector.APPEND(cos(angle))
    position_encoded.APPEND(ADD(embeddings[i], encoded_vector))
  RETURN position_encoded
END FUNCTION
```

Regarding memory management, a possible metadata Table Layout can be as follows: [Start Address, Data Length, Checksum, Flags].

The following are then examples of possible functions for allocation and deallocation of memory:

```
FUNCTION allocate_memory(size):
  IF size <= STATIC_LENGTH:
    address = FIND_FREE_SLOT(static_memory_area)
  ELSE:
    address = FIND_FREE_SLOT(variable_memory_area, size)
  RETURN address
END FUNCTION
FUNCTION deallocate_memory(address):
  UPDATE_METADATA_TABLE(address, FREE)
  RETURN
END FUNCTION
```

Regarding networking and data transfer, handling HTTP requests via raw sockets as described above is helped by efficient networking code that can parse, process, and respond to network traffic. Handling an HTTP request involves parsing the request, processing the payload, and sending back a response. The following are examples:

```
FUNCTION initialize_socket( ):
  socket = CREATE_SOCKET( )
  BIND(socket, PORT 80)
  LISTEN(socket)
  RETURN socket
END FUNCTION
FUNCTION handle_request(socket):
  connection = ACCEPT(socket)
  request = READ(connection)
  payload = PARSE_REQUEST(request)
  response = PROCESS_PAYLOAD(payload)
  WRITE(connection, response)
  CLOSE(connection)
  RETURN
END FUNCTION
```

The following is a simplified example of a complete workflow in an LLM-centric OS of the type generally described herein.
1. Receiving an HTTP Request: The network socket receives an HTTP request.

### Detailed Steps:

| a) | Accept Connection: |
|---|---|
| connection = ACCEPT(network_socket) | |
| b) | Parse HTTP Request: |

request = PARSE_HTTP_REQUEST(connection)
payload = request.payload

2. Processing the Request: The payload is transformed into binary data and then into embeddings.

### Detailed Steps:

| | |
|---|---|
| a) | Binary Data Handling: |

metadata = EXTRACT_METADATA(payload)
binary_data = CONVERT_TO_BINARY(payload)

| | |
|---|---|
| b) | Embedding Transformation: |

embeddings = TRANSFORM_TO_EMBEDDINGS(binary_data)

3. Generating a Response: The transformer model processes the embeddings and generates output embeddings, which are then reverse-transformed into binary data.

### Detailed Steps:

| | |
|---|---|
| a) | Transformer Model Process: |

transformer_output = TRANSFORMER_MODEL_PROCESS(embeddings)

| | |
|---|---|
| b) | Reverse Transformation: |

output_embeddings = TRANSFORM_TO_BINARY(transformer_output)
output_payload = ADD_METADATA(output_embeddings, metadata)

4. Sending the Response: The binary data is formatted into an HTTP response and sent back to the requester.

### Detailed Steps:

| a) | Generate HTTP Response: |
|---|---|
| response = CREATE_HTTP_RESPONSE(output_payload) | |
| b) | Send Response: |
| SEND_RESPONSE(connection, response) | |
| c) | Close Connection: |

CLOSE(connection)

As mentioned above, embodiments of the present invention relate to a computer program product for processing the piece of textual information 200. Such a computer program product is typically arranged to be executed on or by the central server 130, and to perform, when executed, the various method steps described herein. In particular, the computer program product can be arranged to implement the functionality performed by one or several of entities 131-145, in particular entities 132-130. The computer software product can be stored in the memory 140.

Above, preferred embodiments have been described. However, it is apparent to the skilled person that many modifications can be made to the disclosed embodiments without departing from the basic idea of the invention.

For instance, not all tasks performed by the LLM-centric OS described herein need to be processed by an LLM. While LLM:s are highly effective for tasks involving complex data processing and generation, such as natural language understanding and generation, other tasks might be handled by traditional programming constructs or specialized hardware.

Hence, the LLM-centric OS could support also processing of requests, computations and so forth that do not involve any LLM usage.

In various embodiments of LLM-centric OS: s, the LLM:s 150, 160 can be used primarily for tasks that benefit from deep learning capabilities, such as text processing, binary data transformation, and complex decision-making processes. For simpler tasks, such as basic file I/O operations, memory management, and network handling, the LLM-centric OS can then utilize traditional programming logic and direct hardware interactions. Such an approach ensures that the system is not limited to text or conversational tasks but can handle a wide range of functionalities.

More generally, such an LLM-centric OS can be configured to delegate text processing and complex data tasks to the one or several LLM:s 150, 160, leveraging their strengths in these areas. Meanwhile, straightforward operations like file handling and memory management can instead be executed using efficient, traditional programming methods. This hybrid approach would serve to maximize the strengths of both the LLM paradigm and traditional methods, ensuring versatile and efficient system performance across various tasks.

It is understood that everything stated herein regarding the systems, methods and computer program products are equally applicable across these three perspectives.

Hence, the invention is not limited to the described embodiments, but can be varied within the scope of the enclosed claims.

1. A method for processing a piece of textual information, comprising:
parsing the piece of textual information into a set of plaintext input tokens;
individually transforming each of the plaintext input tokens, using a first binary data transformation, to achieve a set of binary input tokens;
individually or collectively transforming each of the set of binary input tokens, using an embedding data transformation, into one or several vectorized input tokens;
feeding the one or several vectorized input tokens to a first neural network; and
receiving a response from the first neural network in the form of one or several vectorized output tokens.

2. The method of claim 1, further comprising:
feeding the one or several vectorized output tokens to a second neural network.

3. The method of claim 1, further comprising:
transforming the one or several vectorized output tokens, using a reverse embedding data transformation, to achieve one or several binary output tokens.

4. The method of claim 3, further comprising:
transforming the one or several binary output tokens, using a second binary data transformation, to achieve one or several plaintext output tokens.

5. The method of claim 3, further comprising:
feeding the one or several binary output tokens to a second neural network.

6. The method of claim 1, wherein:
the first binary data transformation is a compression.

7. The method of claim 1, wherein:
the compression comprises using a set of predetermined pairs of individual plaintext token values and corresponding respective binary token values.

8. The method of claim 1, further comprising:
converting the piece of textual information or the set of plaintext input tokens, prior to the transforming using the first binary data transformation, into a representation using only a limited character set, the limited character set comprising at the most 256 characters, such as at the most 128 characters, such as at the most 64 characters.

9. The method of claim 1, further comprising the following initial steps, performed before the parsing:
individually transforming each of a set of plaintext training tokens, using the first binary data transformation, to achieve a set of binary training tokens;
individually or collectively transforming each of the set of binary training tokens, using the embedding data transformation, to achieve one or several vectorized pieces of training data;
individually transforming each of a set of plaintext desired output tokens, using the first binary data transformation, to achieve a set of binary desired output tokens; and
training the first neural network using the binary training tokens as input data and the binary desired output tokens as output data.

10. A system for processing a piece of textual information, the system comprising:
a parser, configured to parse the piece of textual information into a set of plaintext input tokens;
a first transformer, configured to individually transform each of the plaintext input tokens, using a first binary data transformation, to achieve a set of binary input tokens;
a vectorizer, configured to individually or collectively transform each of the set of binary input tokens, using an embedding data transformation, into one or several vectorized input tokens; and
a neural network interface, arranged to feed the one or several vectorized input tokens to a first neural network and to receive a response from the first neural network in the form of one or several vectorized output tokens.

11. The system of claim 10, further comprising:
a reverse vectorizer, configured to transform the one or several vectorized output tokens, using a reverse embedding data transformation, to achieve one or several binary output tokens.

12. The system of claim 11, further comprising:
a second transformer, configured to transform the one or several binary output tokens, using a second binary data transformation, to achieve one or several plaintext output tokens.

13. The system of claim 10, wherein:
the vectorizer is configured to transform each of the set of binary input tokens into one or several vectorized input tokens taking into consideration self-attention vector information of the each of the set of binary input tokens in relation to a respective local sequence of binary input tokens of the each of the set of binary input tokens in question.

14. The system of claim 10, wherein:
the vectorizer is configured to transform each of the set of binary input tokens into one or several vectorized input tokens taking into consideration positional information of the each of the set of binary input tokens in relation to a respective local sequence of binary input tokens of the each of the set of binary input tokens in question.

15. The system of claim 10, wherein:
the system is configured to associate each of the binary input tokens with metadata specifying positional information for the each of the binary input tokens.

16. The system of claim 10, wherein:
the system is configured to associate each of the binary input tokens with a respective piece of metadata specifying data storage size for the each of the binary input tokens.

17. The system of claim 10, wherein:
the first transformer is configured to produce and store the binary input tokens with a fixed byte size.

18. The system of claim 17, wherein:
the piece of textual information refers to or comprises additional data that is not parsed into corresponding ones of the set of plaintext input tokens, and wherein
the system is configured to store the additional data as variable-length data outside of the dedicated memory area.

19. The system of claim 10, further comprising:
a communication interface configured to receive the piece of textual information and/or the set of plaintext input tokens from an external device, the communication interface further being configured to return the one or several plaintext output tokens to the external device.

20. The system of claim 19, wherein:
the communication interface is configured to receive the piece of textual information and/or the set of plaintext input tokens from the external device, and to return the one or several plaintext output tokens to the external device, via an HTTP socket interface configured to use a raw socket connection for data transfer.

21. A computer program product for processing a piece of textual information, the computer program product being stored on a non-transitory computer readable storage medium and being arranged to, when executing on one or several processors:
parse the piece of textual information into a set of plaintext input tokens;
individually transform each of the plaintext input tokens, using a first binary data transformation, to achieve a set of binary input tokens;
individually or collectively transform each of the set of binary input tokens, using an embedding data transformation, into one or several vectorized input tokens;
feed the one or several vectorized input tokens to a first neural network; and
receive a response from the first neural network in the form of one or several vectorized output tokens.
